(19) United States
(12) Patent Application Publication
(10) Pub. No.: US 2023/0082192 A1
(43) Pub. Date: Mar. 16, 2023

(54) VALVE BOX RISER EXTENSION

(71) Applicant: Bryan Bjerke, Allen, TX (US)

(72) Inventor: Bryan Bjerke, Allen, TX (US)

(21) Appl. No.: 17/472,270

(22) Filed: Sep. 10, 2021

(51) Int. Cl. A01G 25/06; F16K 27/12; F16K 27/00

(52) U.S. Cl. CPC A01G 25/06; F16K 27/003; F16K 27/12

(57) ABSTRACT

A valve box riser extension is disclosed, including a valve box riser extension positioned between a valve box lid and a valve box. A rim is positioned about a perimeter of an exterior surface of the valve box riser extension. The rim is constructed as an inverted wedge having an acute incline angle surface lip portion. The lip portion allows dirt or other material to be placed thereon to prevent the valve box riser extension from being pulled out of the ground when removing the lid.

### TECHNICAL FIELD

Embodiments of the invention relate to irrigation system components and more particularly to valve box components.

### BACKGROUND

Irrigation systems include various valves, irrigation conduit lines, sprinklers, and other known components which are often buried in the ground. Burying sprinkler valves and other precision equipment in the ground has the likelihood of causing many problems over time. Valve boxes are durable structures which house and protect lawn irrigation manifolds and other components necessary for operating an irrigation system. These valve boxes are partially buried in the ground, leaving the top portion unburied so that the lid can be removed to access the components housed therein.

Valve boxes can be buried in sediment or more resilient materials such as concrete. In most cases and especially in residential applications, the valve box is buried in sediment which move, decay, or otherwise change over time. This requires the position of the valve box to be adjusted to maintain the accessibility of the valve box and components therein.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments provided herein relate to a valve box riser extension, including a valve box riser extension positioned between a valve box lid and a valve box. A rim is positioned about a perimeter of an exterior surface of the valve box riser extension. The rim is constructed as an inverted wedge having an acute incline angle surface lip portion. The lip portion allows dirt or other material to be placed thereon to prevent the valve box riser extension from being pulled out of the ground when removing the lid.

In general, the embodiments described herein relate to a valve box riser extension utilized to raise the lid of a valve box such that the lid remains accessible to allow access to the components stored within the valve box.

The embodiments are an improvement over known practices in the arts by removing the need to dig up the riser box and refortify the foundation under the valve box. Instead, the valve box riser extension is positioned between the partially buried valve box and the lid to raise the lid to a level at or above the ground level. In the event that the valve box continues to sink, additional valve box riser extensions can be stacked on top of one another to raise the lid to a sufficient level. This greatly reduces the maintenance efforts needed to maintain the irrigation components housed within the valve box.

The valve box riser extension may also aid in strengthening the upper rim of the valve box, which may be malformed due to increasing pressures, eventually resulting in the structural failure of the valve box.

In one aspect, the valve box riser extension includes a top portion and a bottom portion separated by the rim.

In one aspect, the top portion has a circumference larger than a circumference of the bottom portion.

In one aspect, the valve box lid is removably engaged with the valve box riser extension to permit selective access to an interior of the valve box.

In one aspect, the valve box riser extension is stackable to permit a plurality of valve box riser extensions to be releasably engaged with one another.

In one aspect, the valve box riser extension includes an interior surface and the exterior surface forming a sidewall sufficiently rigid to prevent bending of the valve box riser extension.

In one aspect, the interior surface is comprised of an interior lip to permit the lid to rest thereon when engaged thereto.

In one aspect, the interior lip permits a second valve box riser extension to rest thereon.

In one aspect, the acute incline angle surface lip portion includes a first circumference which is larger than the circumference of the valve box lid.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates an exploded view of the valve box, the valve box riser extension, and the valve box lid, according to some embodiments;

FIG. 2 illustrates a side elevation view of the valve box riser extension, according to some embodiments;

FIG. 3 illustrates a top plan view of the valve box riser extension, according to some embodiments; and

FIG. 4 illustrates a side elevation view of the valve box riser in a stacked configuration, according to some embodiments.

### DETAILED DESCRIPTION

The specific details of the single embodiment or variety of embodiments described herein are set forth in this application. Any specific details of the embodiments are used for demonstration purposes only, and no unnecessary limitation or inferences are to be understood therefrom.

Before describing in detail exemplary embodiments, it is noted that the embodiments reside primarily in combinations of components related to the system. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments described herein relate to a valve box riser extension utilized to raise the lid of a valve box such that the lid remains accessible to allow access to the components stored within the valve box. The valve box riser extension is positioned between the valve box lid and the valve box. Further, the valve box riser extension is stackable to allow two or more valve box riser extensions to be stacked on top of one another as required to keep the lid at or above the ground level.

Valve boxes allow for routine maintenance of the irrigation system while protecting the irrigation components housed therein. Often, valve boxes can be installed which are too small for maintenance to be performed on the internal components. This results in the valve box needing to be dug out of the ground for maintenance to be completed. Another common problem is using a valve box made of materials not resilient enough to withstand the elements, pressure applied from the ground substrate, or withstand degradation over time. Further, valve boxes may become buried due to shifts in the ground substrate, or a heavy object being placed (permanently or temporarily) over the top of the valve box. This results in the valve box being driven deeper into the ground than it is designed and restricting access to the valve box. During installation, if the foundation of the valve box is not stabilized, the valve box may sink into the ground over time. It is important for the valve box to be measured and properly fitted into the ground to ensure the valve box remains accessible. Otherwise, the valve box must be dug out of the ground and the foundation fortified to fix the problem.

As used herein, the term “valve box” is utilized to conceal and protect the valves, fittings, wires, manifolds and other components which are necessary to form a functional irrigation system. The valve box is constructed of a resilient material (often a rigid plastic or other rigid materials such as concrete, wood, and metals) to protect the irrigation components housed therein. The valve box includes a housing which is buried at least partially in the ground and is dimensioned to conceal and protect the valves, fittings, wires, manifolds, etc. A removeable lid covers the opening at the top of the valve box. The lid is accessible from the top of the box and allows for access to the irrigation components during maintenance. The valve box and lid protect the irrigation components from vandalism, the elements (e.g., excessive debris, moisture, etc.), and damage caused by lawn mowers and string trimmers.

As used herein, the term “irrigation components” refers to any combination of components which operate the irrigation system including valves, fittings, wires, and manifolds.

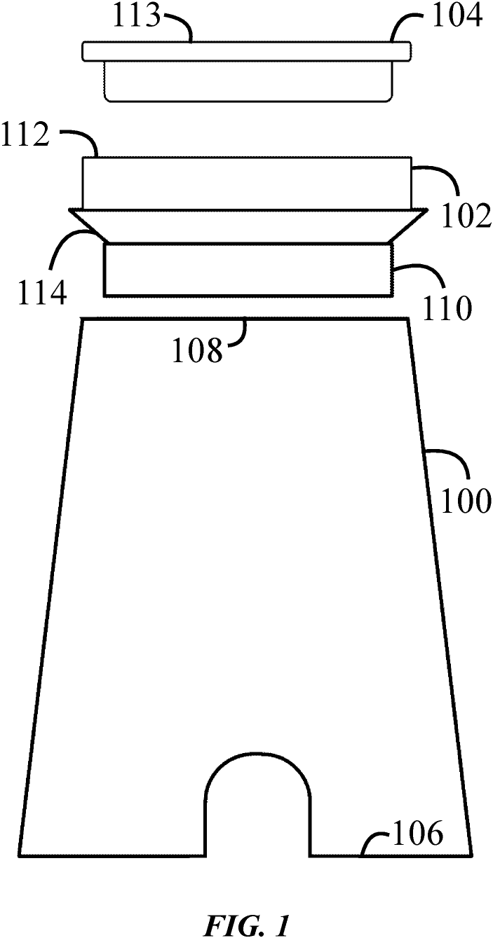

FIG. 1 illustrates an exploded view of the valve box 100, the valve box riser extension 102, and the valve box lid 104. The valve box 100 is positioned within the ground during installation of the valve box 100 and/or the irrigation components which are housed therein. The valve box 100 include a bottom 106 which rests upon the foundation formed by the ground sediment. The foundation may be supplemented with rock or other material to prevent the valve box 100 from sinking over time. The top edge 108 of the valve box 100 is positioned at about ground level to allow for access to the interior cavity of the valve box and irrigation components housed therein. The extension riser 102 is positioned between the valve box 100 and the valve box lid 104. The valve box lid 104 releasably engages with the valve box riser extension 102, such that the valve box lid 104 can be selectively removed to access the irrigation components stored within the valve box 100. The valve box riser extension 102 includes a bottom portion 110 and a top portion 112 separated by a rim 114. Bottom portion 110 is attached to the top edge 108 of the valve box 100 while the top portion 112 is releasably engaged with the valve box lid 104. The rim 114 prevents the valve box riser extension 102 from being pulled out of the ground when removing the valve box lid 104.

One skilled in the arts will readily understand that the rim 114 may not be tapered. However, a tapered shape may provide a better fit between each component.

In some embodiments, the bottom portion 110 of the valve box riser extension 102 is releasably engaged with the valve box 100 to allow for the selective attachment and removal of the riser box rise extension 102 with the valve 100. In such, the valve box riser extension 102 can be fitted to an existing valve box 100 which has previously been positioned in the ground.

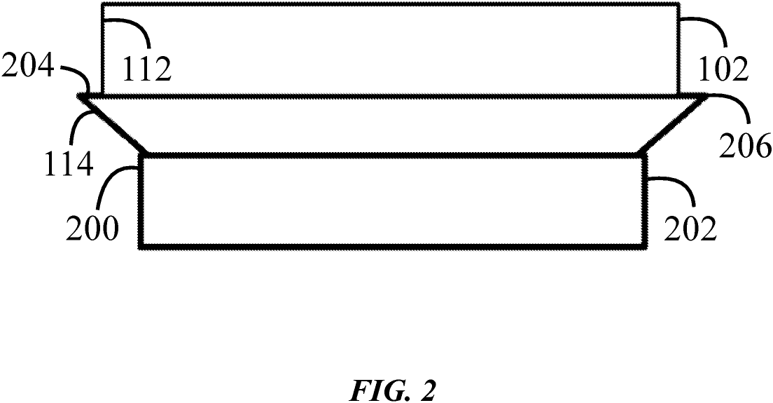

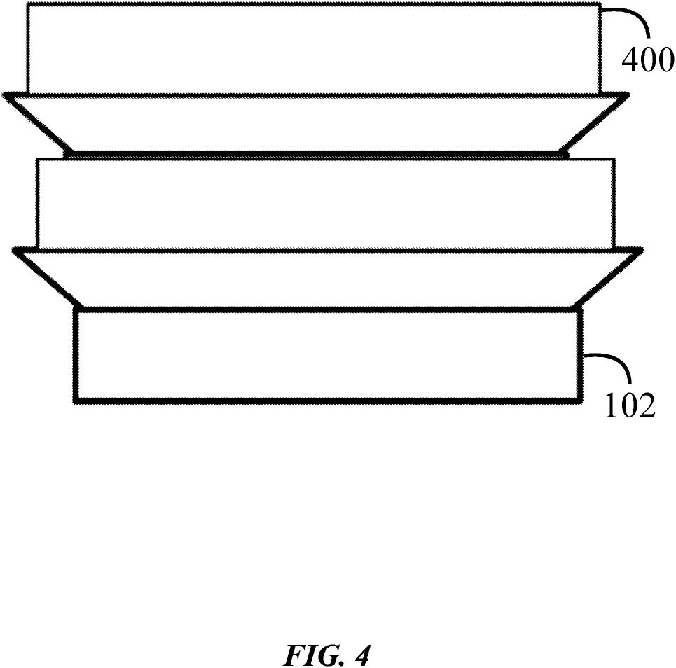

FIG. 2 illustrates a side elevation view of the valve box riser extension 102, according to an exemplary embodiment. The valve box riser extension 102 includes the bottom portion 110, the top portion 112 and the rim 114 as discussed hereinabove. The rim 114 is positioned about the perimeter 200 of the exterior surface 202 of the valve box riser extension 102. The rim 114 is constructed as an inverted wedge having an acute incline angle surface lip portion 204 having a first circumference 206 which is larger than the circumference of the valve box lid. The rim includes an interior lip which allows for additional valve box riser extensions 102 to be stacked on top of one another as illustrated and described in FIG. 4.

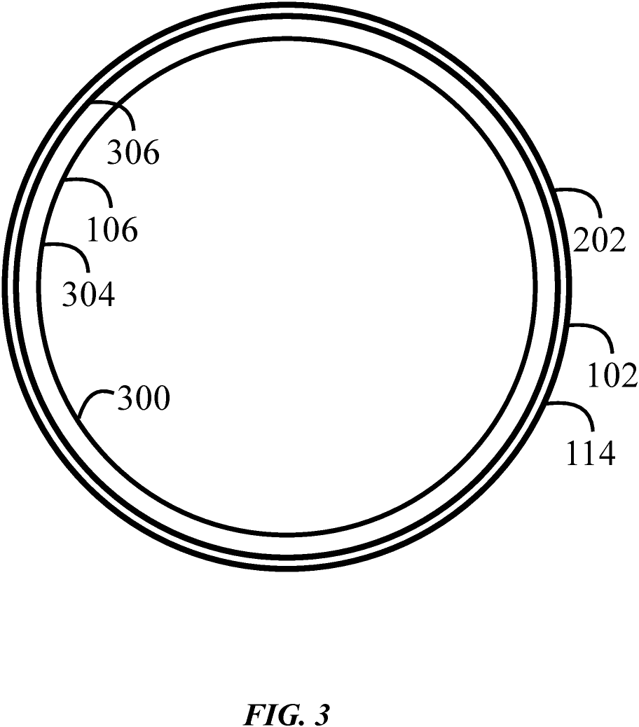

FIG. 3 illustrates a top plan view of the valve box riser extension 102 in an exemplary embodiment. The valve box riser extension 102 includes an exterior surface 202 and an interior surface 300. An interior ledge 304 allows the valve box lid or additional valve box riser extension 102 to rest thereon. The valve box riser extension 102 is constructed having a sidewall 306 width sufficient to prevent bending or other malformation of the valve box riser extension 102 and supports the structure of the valve box when positioned thereon.

FIG. 4 illustrates a side elevation view of the valve box riser 102 in a stacked configuration wherein a first valve box riser extension 102 and a second valve box riser extension 400 are engaged with one another. The stackability of the valve box riser extensions 102 allow for a plurality of valve box riser extensions to be stacked to accommodate valve boxes which have sunk into the ground to a depth too deep for a single valve box riser extension 102. In such, those servicing the valve box and irrigation components therein can continue to be accessed without the need to dig out the valve box and fortify the foundation underneath.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A valve box riser extension, comprising:
a valve box riser extension positioned between a valve box lid and a valve box;
a rim positioned about a perimeter of an exterior surface of the valve box riser extension, the rim constructed as an inverted wedge having an acute incline angle surface lip portion to prevent the valve box riser extension from being lifted when removing the lid.

2. The valve box riser extension of claim 1, wherein the valve box lid is removably engaged with the valve box riser extension to permit selective access to an interior of the valve box.

3. The valve box riser extension of claim 2, wherein the interior of the valve box is dimensioned to house one or more irrigation components.

4. The valve box riser extension of claim 1, wherein the valve box riser extension is stackable to permit a plurality of valve box riser extensions to be releasably engaged with one another.

5. The valve box riser extension of claim 1, wherein the valve box riser extension includes an interior surface and the exterior surface forming a sidewall sufficiently rigid to prevent bending of the valve box riser extension.

6. The valve box riser extension of claim 5, wherein the interior surface is comprised of an interior lip to permit the lid to rest thereon when engaged thereto.

7. The valve box riser extension of claim 6, wherein the interior lip permits a second valve box riser extension to rest thereon.

8. A valve box riser extension system, comprising:
a valve box riser extension positioned between a valve box lid and a valve box;
a rim positioned about a perimeter of an exterior surface of the valve box riser extension, the rim constructed as an inverted wedge having an acute incline angle surface lip portion to prevent the valve box riser extension from being lifted when removing the lid, wherein the valve box riser extension increases the length between a bottom of the valve box and the top of the valve box lid to retain access to the valve box lid during maintenance of a plurality of irrigation components housed within an interior of the valve box.

9. The valve box riser extension system of claim 8, wherein the valve box riser extension includes a top portion and a bottom portion separated by the rim.

10. The valve box riser extension system of claim 9, wherein the top portion has a circumference larger than a circumference of the bottom portion.

11. The valve box riser extension system of claim 8, wherein the valve box lid is removably engaged with the valve box riser extension to permit selective access to an interior of the valve box.

12. The valve box riser extension system of claim 8, wherein the valve box riser extension is stackable to permit a plurality of valve box riser extensions to be releasably engaged with one another.

13. The valve box riser extension system of claim 8, wherein the valve box riser extension includes an interior surface and the exterior surface forming a sidewall sufficiently rigid to prevent bending of the valve box riser extension.

14. The valve box riser extension system of claim 13, wherein the interior surface is comprised of an interior lip to permit the lid to rest thereon when engaged thereto.

15. The valve box riser extension system of claim 14, wherein the interior lip permits a second valve box riser extension to rest thereon.

16. The valve box riser extension system of claim 8, wherein the acute incline angle surface lip portion includes a first circumference which is larger than the circumference of the valve box lid.

17. A valve box riser extension system, comprising:
a valve box riser extension positioned between a valve box lid and a valve box;
a rim positioned about a perimeter of an exterior surface of the valve box riser extension, the rim constructed as an inverted wedge having an acute incline angle surface lip portion to prevent the valve box riser extension from being lifted when removing the lid, wherein the valve box riser extension increases the length between a bottom of the valve box and the top of the valve box lid to retain access to the valve box lid during maintenance of a plurality of irrigation components housed within an interior of the valve box;
an interior surface of the valve box riser including a lip to permit the valve box lid or a second valve box riser to rest thereon.

18. The valve box riser extension system of claim 17, wherein the valve box riser extension includes a top portion and a bottom portion separated by the rim.

19. The valve box riser extension system of claim 18, wherein the top portion has a circumference larger than a circumference of the bottom portion.

20. The valve box riser extension system of claim 19, wherein the acute incline angle surface lip portion includes a first circumference which is larger than the circumference of the valve box lid.
